(19) United States
(12) Patent Application Publication
(10) Pub. No.: US 2006/0123975 A1
(43) Pub. Date: Jun. 15, 2006

(54) Systems and methods for creating personalized or tailored compositions

(76) Inventor: Nancy Lou Swanson, Midlothian, VA (US)

Correspondence Address: Mrs. Nancy L. Swanson, 16325 Dragonnade Trail, Midlothian, VA, 23113, US

(21) Appl. No.: 11/008,598

(22) Filed: Dec. 9, 2004

(51) Int. Cl. G10H 1/00

(52) U.S. Cl. 84/600

(57) ABSTRACT

Personalizing or tailoring techniques for creative compositions are provided. Methods and systems consistent with the present invention may create personalized or tailored audio and/or video compositions. Methods and systems consistent with the present invention may collect audio and/or visual tailoring requests from one individual or a plurality of individuals. The method and system may associate requests with: a sound or plurality of sounds, an image or plurality of images. The method and system may associate requests with at least one message. The method and system may combine the sounds, and/or the images with a message or plurality of messages and create at least one personalized or tailored composition. The method and system may distribute the personalized or tailored composition to at least one individual, through one or a plurality of communication methods. The method and system may store the personalized or tailored composition.

### BACKGROUND OF THE INVENTION

1. Field of the Invention

The present invention relates to the personalization of creative compositions including, but not limited to, sound or visual image, music and motion pictures for individuals or groups. More particularly, the invention relates to systems and methods for composing, creating, enhancing and distributing personalized sound and/or video images including, but not limited to, tailored music or tailored motion pictures to an individual or a plurality of people. The present invention may also be used in any other situation where personalized or tailored sound or visual images may be of benefit, including but not limited to, live theatre or musical performance, interactive computer education products, or composition tools.

2. Description of the Related Art

Traditionally, music is created by a composer and that music is fixed into a tangible medium. Those mediums include, but are not limited to, written musical notation on paper, or other medium, analog tape, digital tape, vinyl pressings, Compact Disc (CD), Digital Video Disc (DVD), laser disc, Integrated circuit storage, Random Access Memory (RAM), Read Only Memory (ROM), fixed computer hard disk, removable computer disk, flexible disk, floppy disk, removable flash memory (thumb drives) and other mediums as needed and appropriate.

Prior to this invention, sound and music was fixed in a tangible medium, often as a result of a plurality of recording sessions or tracks. The final production was then created by mixing the plurality of sessions or tracks into a final copy. Throughout the process of mixing, various effects are added to the recorded sound. The final composition is often completed by adding additional effects. At the end of the process a master recording is created. This master version is then often stored on any of a number of fixed mediums including but not limited to, analog tape, digital tape, vinyl pressings, Compact Disc (CD), Direct Video Disc (DVD), laser disc, Integrated circuit storage, Random Access Memory (RAM), Read Only Memory (ROM), fixed computer hard disk, removable computer disk, flexible disk, floppy disk, removable flash memory (thumb drives)

To date, there is no known method or system in which recorded sound and music, can be personalized or tailored for an individual or plurality of individuals. More particularly, there exists a need for systems and methods that assist in the personalization or tailoring of music and visual images to individuals.

Similarly, visual arts are created and fixed into a tangible medium. Those mediums include, but are not limited to paper, canvas, or other visual medium, analog video tape, digital video tape, Compact Disc (CD), Digital Video Disc (DVD), laser disc, Integrated circuit storage, Random Access Memory (RAM), Read Only Memory (ROM), fixed computer hard disk, removable computer disk, flexible disk, floppy disk, removable flash memory (thumb drives) and other mediums as needed and appropriate.

Prior to this invention, a visual was fixed in a tangible medium, often as a result of a plurality of filming or taping sessions or tracks. The final production was then created by editing and mixing the plurality of sessions or tracks into a final copy. Throughout the process of mixing, various effects are added to the edited tracks or sessions. The final creation is often completed by adding additional effects. At the end of the process a master copy of the completed work is created. This master version is then often stored on any of a number of fixed mediums including but not limited to, film, analog video tape, digital video tape, Compact Disc (CD), Direct Video Disc (DVD), laser disc, Integrated circuit storage, Random Access Memory (RAM), Read Only Memory (ROM), fixed computer hard disk, removable computer disk, flexible disk, floppy disk, removable flash memory (thumb drives).

To date, there is no known method or system in which visual creations can be personalized or tailored for an individual or plurality of individuals. More particularly, there is thus a need for systems and methods that assist in the personalization or tailoring of visual creations to individuals.

### SUMMARY OF THE INVENTION

Consistent with the present invention, systems and methods for personalizing or tailoring sounds and/or music, visuals and/or video to defined requests are provided. Such personalized or tailored music may include, but is not limited to, announcing an individual's name or a plurality of individual names, prior to, during, or at the end of a song and or audio clip and or visual, speaking or singing a dedication to an individual or plurality of individuals prior to, during, or at the end of a song and or audio and or visual, announcing, speaking or singing a remembrance event such as an anniversary, birthday, religious holiday or other event, to an individual or plurality of individuals prior to, during, or at the end of a song and or audio and or visual,

In one embodiment, a method for personalizing or tailoring music is provided. The method may include obtaining personalization requests from an individual customer or a plurality of customers. The method may further include associating each customer request with other customer information to create a record or plurality of records, wherein the customer information includes data identifying the customer's name, and/or the name of the person for whom the music and/or audio and/or visual will be personalized or tailored. The method may further include using the information obtained to access a database containing recorded names, events, and places. The method may further include identifying at least one name, event or location for which the music and or audio and or visual will be tailored. The method may further include copying the name, and/or event, and/or place. The method may further include transferring the name, and/or place and/or event from one fixed or temporary medium to another fixed or temporary medium. The method may further include, transmitting, broadcasting or recording the name, and or place and or event to a fixed or temporary medium along with a musical, and/or audio and or/visual composition. The method may further include transmitting, broadcasting or manufacturing the personalized or tailored musical and or audio and or visual composition. The method may further include distributing the personalized or tailored musical and or audio and or visual composition. The method may further include collecting money or other valuable consideration for the services rendered in the personalization and tailoring of the musical and/or audio and/or visual composition.

In another embodiment, a method for personalizing or tailoring video is provided. The method may include obtaining personalization requests from an individual customer or a plurality of customers. The method may further include associating each customer request with other customer information to create a record or plurality of records, wherein the customer information includes data identifying the customer's name, and/or the name of the person for whom the visual will be personalized or tailored. The method may further include using the information obtained to access a database containing recorded names, events, and places. The method may further include identifying at least one name, event or location for which the visual will be tailored. The method may further include copying the name, and/or event, and/or place. The method may further include transferring the name, and/or place and/or event from one fixed or temporary medium to another fixed or temporary medium. The method may further include, transmitting, broadcasting or recording the name, and or place and or event to a fixed or temporary medium along with a visual composition. The method may further include transmitting, broadcasting or manufacturing the personalized or tailored visual composition. The method may further include distributing the personalized or tailored visual composition. The method may further include collecting money or other valuable consideration for the services rendered in the personalization and tailoring of the visual composition.

It is to be understood that both the foregoing general descriptions and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings provide a further understanding of the invention and are incorporated in and constitute a part of this specification. The drawings illustrate various embodiments of the invention, and, together with the description, serve to explain the principles of the invention. In the drawings:

FIG. 1A illustrates an exemplary system environment consistent with the present invention;

FIG. 1B illustrates an exemplary block diagram for gathering inputs and accessing information consistent with the present invention;

FIG. 1C illustrates a an exemplary system for creating the tailored or personalized audio or visual output consistent with the present invention;

FIG. 1D illustrates an exemplary tailoring modules consistent with the present invention;

FIG. 2A shows a flow chart for an exemplary method of creating a personalized or tailored audio output consistent with the present invention;

FIG. 2B shows a diagram of an exemplary method for creating at least one personalized or tailored audio output from at least one tailored message, the tailored output being placed before the audio file consistent with the present invention;

FIG. 2C shows a diagram of an exemplary method for creating at least one personalized or tailored audio output from at least one tailored message, the tailored output being placed before the audio file and after the audio file consistent with the present invention;

FIG. 2D shows a diagram of an exemplary method for creating at least one personalized or tailored audio output from at least one tailored message, the tailored output being placed before the audio file, placed after the audio file, and including a audio file from the input consistent with the present invention;

FIG. 3A shows a flow chart for an exemplary method of creating a personalized or tailored video output consistent with the present invention;

FIG. 3B shows a diagram of an exemplary method for creating at least one personalized or tailored video output from at least one tailored message, the tailored output being placed before the video file consistent with the present invention;

FIG. 3C shows a diagram of an exemplary method for creating at least one personalized or tailored video output from at least one tailored message, the tailored output being placed before the video file and after the video file consistent with the present invention;

FIG. 3D shows a diagram of an exemplary method for creating at least one personalized or tailored video output from at least one tailored message, the tailored output being placed before the video file, placed after the video file, and including an audio or video file from the input consistent with the present invention;

FIG. 4A shows an exemplary table showing the relationships between inputs, names, indexes, recorded tailoring messages, and run times consistent with the present invention;

FIG. 4B shows an exemplary table showing the relationships between inputs, locations referencing a female, indexes, recorded tailoring messages, and run times consistent with the present invention;

FIG. 4C shows an exemplary table showing the relationships between inputs, locations referencing a male, indexes, recorded tailoring messages, and run times consistent with the present invention;

FIG. 4D shows an exemplary table showing the relationships between inputs, events, indexes, recorded tailoring messages, and run times consistent with the present invention;

FIG. 4E shows an exemplary table showing the relationships between inputs, single names, indexes, recorded tailoring messages, and run times consistent with the present invention;

5A shows an exemplary table showing a relationship between an index, recorded music, and run times consistent with the present invention;

FIG. 6A shows an exemplary table showing the relationships between inputs, names, indexes, recorded tailoring messages run times, sound indicators and video indicators consistent with the present invention;

FIG. 6B shows an exemplary table showing the relationships between inputs, locations referencing a female, indexes, recorded tailoring messages, run times, sound indicators and video indicators, consistent with the present invention;

FIG. 6C shows an exemplary table showing the relationships between inputs, locations referencing a male, indexes, recorded tailoring messages, run times, sound indicators and video indicators consistent with the present invention;

FIG. 6D shows an exemplary table showing the relationships between inputs, events, indexes, recorded tailoring messages, run times, sound indicators and video indicators consistent with the present invention;

FIG. 6E shows an exemplary table showing the relationships between inputs, single names, indexes, recorded tailoring messages, run times, sound indicators and video indicators consistent with the present invention;

7A shows an exemplary table showing a relationship between an index, recorded video images, run times, sound indicators and video indicators consistent with the present invention

### GLOSSARY OF TERMS

In order to more clearly discuss the technology consistent with the present invention, the following definition of terms may be useful:

Creative Composition—any published or unpublished work which may include, but is not limited to, a sound, sounds, audio, music, musical phrases, an image, images, visuals, audio visual compositions, video, video clips, motion pictures, video games, computer games, or any other creative work that may be fixed into any number of tangible mediums.

Audio—published or unpublished sound which may be fixed or is not fixed into any number of tangible mediums which may include, but is not limited to, any analog or digital or printed medium that can be experienced aurally,

Visual—published or unpublished image which may be fixed or is not fixed into any number of tangible mediums which may include, but is not limited to, any analog or digital or printed medium that can be experienced by sight,

Music—published or unpublished plurality of sounds which may be fixed or is not fixed into any number of tangible mediums which may include, but is not limited to, any analog or digital or printed medium that can be experienced aurally;

Video—published or unpublished plurality of images which may be fixed or not fixed into any number of tangible mediums which may include, but is not limited to, any analog or digital or printed medium that can be experienced by sight;

Musical Phrase—a segment or plurality of segments of audio or music that may be experienced as a complete entity;

Video Clip—a segment or plurality of segments of video that may be experienced as a complete entity;

Run Time—the elapsed time from the moment an audio event or visual event begins until it ends;

Personalized or tailored audio composition—a composition created by and consistent with this invention which may include one or a plurality of audio images for an individual to experience;

Personalized or tailored visual composition—a composition created by and consistent with this invention which may include one or a plurality of visual images and may include one or a plurality of audio images for an individual to experience;

Customer—an individual or group of individuals who may initiate the request to tailor the audio or visual, the customer may be the individual or group of individuals who pay for the personalizing or tailoring effort. The customer may or may not be the final beneficiary of the personalizing or tailoring effort.

Beneficiary—The individual or plurality of individuals who directly or indirectly benefits from the personalized or tailored effort. The beneficiary may be someone other than the individual or group of individuals who paid for the personalization or tailoring effort.

Message over Black—A single blank (Black) video image held constant while the audio message is played. This may also be referred to as Voice over Video.

Freeze Frame—A single video image held constant for a period of time.

### Overview of the Preferred Audio Embodiment

The preferred embodiment of the present invention is a method and system comprising at least one tailored message and at least one sound that produces at least one personalized or tailored audio composition. The preferred embodiment may be comprised of at least one sound or musical phrase, at least one tailored message, which when combined, may create at least one personalized or tailored composition, the personalized or tailored composition may then be transmitted or recorded to a storage location which may be digital, the personalized or tailored composition may be output into another form of audio that may then be, transferred, recorded, played or performed in one or a plurality of outputs.

### Overview of the Preferred Video Embodiment

The preferred embodiment of the present invention is a method and system comprising at least one tailored message and at least one visual that produce at least one personalized or tailored visual composition. The preferred embodiment may be comprised of at least one visual or video clip, at least one tailored message, which when combined, may create at least one personalized or tailored composition, the personalized or tailored composition may then be transmitted or recorded to a storage location which may be digital, the personalized or tailored composition may be output into video that may then be, transferred, recorded, played or performed in one or a plurality of outputs.

### DETAILED DESCRIPTION OF THE INVENTION

Systems and methods consistent with the present invention take inputs from one or a plurality of sources and tailor creative compositions. The present invention also provides for creating, storing and or distributing personalized or tailored compositions.

From the beginning of recorded human history, audio and visual creations have helped humanity find enjoyment with their world. The audio and visual arts strike something very deep in many individuals. Creative people who produce audio and visual arts do so for any number of reasons, but often it is to reach someone and touch them in a very deep manner. Prior to this invention there was no convenient way for an audio or visual artist to reach an individual with a personal message that could build upon and enhance the overall experience of the individual who enjoys the artist's creative compositions.

In a related manner, many consumers of audio or visual creations would very much like to hear and or see the creator of the artistic effort dedicate the audio or visual creation to themselves or to a third party. Consumers often desire closer contact with artists. More personalized or tailored contact helps individuals feel closer to the artist or the artist's work.

In addition, many consumers of creative compositions feel the artist has created a work that expresses feelings that the consumer may not be able to express. To assist consumers, there exists a need to allow consumers to tailor audio or visual creations for themselves or other individuals. There exists a need to enable consumers to dedicate, personalize or tailor sound, audio, visual images, songs, videos, and motion pictures in a manner that protects copyright, protects the artist, and the artist's image, and still allows for the dedication of the sound or visual.

In one embodiment, audio may be stored in a digital format on a computer server. The artist who created the original audio may have spoken or sung a tailored message and may have stored it in a digital or analog format. A fan who enjoys the artist's work may request, through any one of many input request methods, a personalized version of the audio. The system and method consistent with the invention may combine the tailored message and the original audio, the system and the method may then record the components together which may create a digital or analog personalized or tailored audio composition which may be transmitted to the fan in any acceptable method. Sources of the various audio components are merely exemplary and such audio or video could be obtained from other sources, for example, analog recordings, video clips, or digital versions of motion pictures to name just a few.

In another embodiment, audio may be stored in a digital format on a computer server. The artist who created the original audio may have spoken or sung a tailored message and may have stored it in a digital or analog format. One or more individuals who want to have a tailored song created for a fan who enjoys the artist's work may request through any one of many input request methods, a personalized version of the audio. The system and method consistent with the invention may combine the tailored message and the original audio, the system and the method may then record the components together which may create a digital or analog personalized or tailored audio composition which may be transmitted to the fan, or beneficiary, in any acceptable method. One skilled in the art will appreciate that sources of the various audio components are merely exemplary and such audio or video could be obtained from other sources, for example, analog recordings, video clips, or digital versions of motion pictures to name just a few.

In one embodiment, audio may be stored in a digital format on a computer server. An individual, or a plurality of individuals, other than the artist who created the original audio may have spoken or sung a tailored message and may have stored it in a digital or analog format, a fan who enjoys the artist's work may request through any one of many input request methods, a personalized version of the audio, the system and method consistent with the invention may combine the tailored message and the original audio, the system and the method may then record the components together which may create a digital or analog personalized or tailored audio composition which may be transmitted to the fan in any acceptable method. The sources of the various audio components are merely exemplary and such audio or video could be obtained from other sources, for example, analog recordings, video clips, or digital versions of motion pictures to name just a few.

In another embodiment audio may be stored in a digital format on a computer server. An individual, or a plurality of individuals other than the artist who created the original audio, may have spoken or sung a tailored message and may have stored it in a digital or analog format. One or more individuals who want to have a tailored song created for a fan who enjoys the artist's work may request, through any one of many input request methods, a personalized version of the audio, the system and method consistent with the invention may combine the tailored message and the original audio, the system and the method may then record the components together which may create a digital personalized or tailored audio composition which may be transmitted to the fan, or beneficiary, in any acceptable method. One skilled in the art will appreciate that sources of the various audio components are merely exemplary and such audio or video could be obtained from other sources, for example, analog recordings, video clips, or digital versions of motion pictures to name just a few.

In one embodiment a visual image, video, video clip, television production, or motion picture may be stored in a digital format on a computer server. The artist who created, or worked on the original visual image, video, video clip, television show, or motion picture may have spoken, or sung, a tailored message, or may have appeared on a video clip with a tailored message and may have stored it in a digital format. A fan who enjoys the artist's work may request a personalized version of the video, the system and method consistent with the invention may combine the tailored message and the original visual, the system and the method may then record the components together which may create a digital personalized or tailored visual composition which may be transmitted to the fan in any acceptable method. Sources of the various audio components are merely exemplary and such audio or video could be obtained from other sources, for example, analog recordings, video clips, or digital versions of motion pictures to name just a few.

In another embodiment, visual image, video, video clip, television production, or motion picture may be stored in a digital format on a computer server. The artist who created, or worked on the original visual image, video, video clip, television show, or motion picture may have spoken, or sung, a tailored message, or may have appeared on a video clip with a tailored message and may have stored it in a digital format. One or more individuals who want to have a tailored version of the visual created for a fan who enjoys the artist's work may request a personalized version of the visual, the system and method consistent with the invention may combine the tailored message and the original visual, the system and the method may then record the components together which may create a digital personalized or tailored visual composition which may be transmitted to the fan, or beneficiary, in any acceptable method. One skilled in the art will appreciate that sources of the various audio components are merely exemplary and such audio or video could be obtained from other sources, for example, analog recordings, video clips, or digital versions of motion pictures to name just a few.

In one embodiment visual image, video, video clip, television production, or motion picture may be stored in a digital format on a computer server. An individual or plurality of individuals, other than the artist who created, or worked on the original visual image, video, video clip, broadcast television show, or motion picture may have spoken, or sung, a tailored message, or may have appeared on a video clip with a tailored message and may have stored it in a digital format. A fan who enjoys the artist's work may request a personalized version of the visual, the system and method consistent with the invention may combine the tailored message and the original visual, the system and the method may then record the components together which may create a digital personalized or tailored visual composition which may be transmitted to the fan in any acceptable method. The sources of the various audio components are merely exemplary and such audio or video could be obtained from other sources, for example, analog recordings, video clips, or digital versions of motion pictures to name just a few.

In another embodiment a visual image, video, video clip, television production, or motion picture may be stored in a digital format on a computer server. An individual or plurality of individuals, other than the artist who created, or worked on the original visual image, video, video clip, broadcast television show, or motion picture may have spoken, or sung, a tailored message, or may have appeared on a video clip with a tailored message and may have stored it in a digital format. One or more individuals who want to have a tailored song created for a fan who enjoys the artist's work may request a personalized version of the visual, the system and method consistent with the invention may combine the tailored message and the original visual, the system and the method may then record the components together which may create a digital personalized or tailored visual composition which may be transmitted to the fan, or beneficiary, in any acceptable method. One skilled in the art will appreciate that sources of the various audio components are merely exemplary and such audio or video could be obtained from other sources, for example, analog recordings, video clips, or digital versions of motion pictures to name just a few.

### DETAILED DESCRIPTION OF THE DRAWINGS

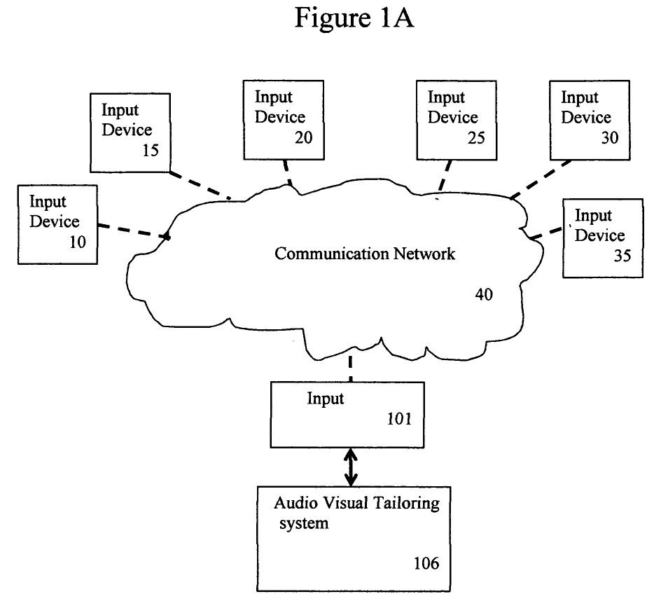

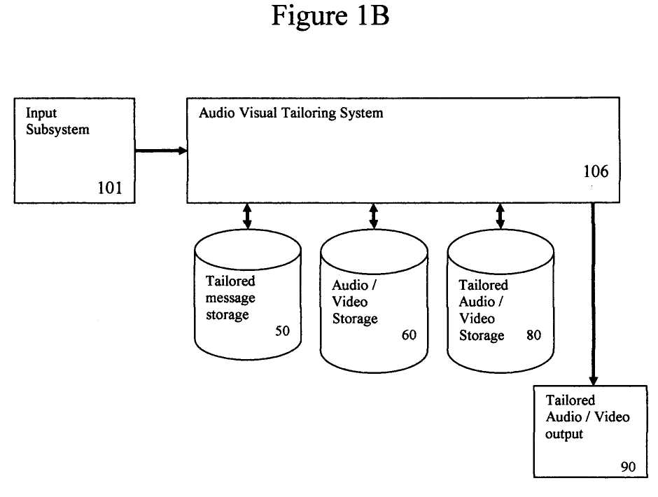

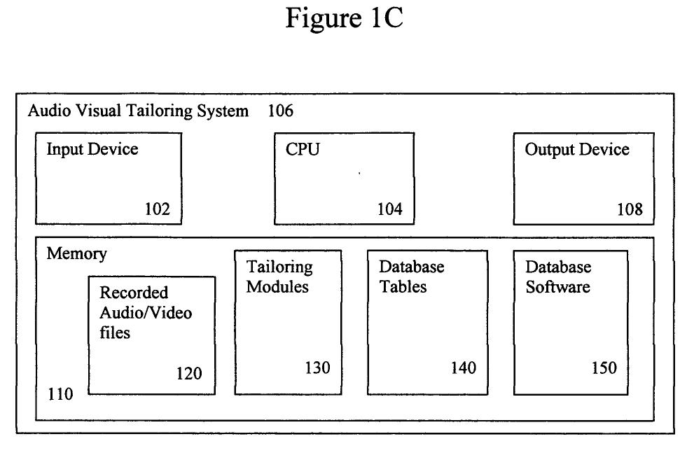

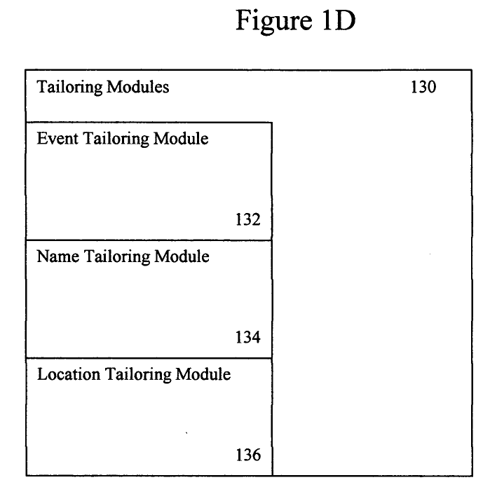

FIG. 1A illustrates an exemplary block diagram of an audio or visual tailoring system consistent with the present invention. As shown in FIG. 1A, a customer 10 may be connected via network 40 to an input subsystem 101 which is in turn connected to at least one audio or visual tailoring system 106. Although one exemplary audio or visual tailoring system is shown in FIG. 1A, connected to 6 exemplary customer input devices, an audio or visual tailoring system may have one or more customers connected to or accessing it at any one time. A plurality of individuals may be accessing or using the system at any time. In addition, a plurality of audio or visual tailoring systems 106 may be included in the invention. Network 10 may comprise any type of networking arrangement used to exchange information. For example, network 40 may be the Internet, a private data network, or a virtual private network using a public network such as the Internet. Network 40 may also include a public switched telephone network (PSTN) and/or a wireless network and/or a satellite network. Network 40 may be the national postal system or its equivalent. Customer 10 may represent any number of customers that desire personalized or tailored audio or visual compositions. These customers may access the audio or visual tailoring system in exchange for payment via a particular payment system For example, customer 10 may be utilizing a personal computer to access an input subsystem 101 web site which assists in getting the necessary data to facilitate the audio or visual tailoring from the customer. Input subsystem 101 may be at least one of the following, a website, a call center with people answering calls, Virtual Private Network (VPN), A Bluetooth device Voice activated response (VAR) system, Voice Response unit (VRU) a cellular or mobile phone voice system, a cellular or mobile phone Short Message Service (SMS) system, a mail processing system in which paper requests arrive by mail and are entered into the Audio Visual Tailoring System 106 by people or machines, or any other subsystem that can gather the appropriate information for the Audio Visual Tailoring System 106. For illustrative purposes only, this information may include but is not limited to, at least one of the following: the requested creative composition, a requested message, customer name, beneficiary name, billing address, phone number, credit or debit card number, credit card expiration date, PIN number, email address, tailoring name, tailoring event, tailoring location, desired delivery date, desired format for output, to name a few. Customer requests can come from at least one or a plurality of inputs which may include, but are not limited to, personal phone call, a computational device, a wireless network input, computer initiated internet session, Blackberry, Blueberry, Bluetooth, Palm Pilot, Personal Digital Assistants, (PDA) Cell phone, written requests by mail or email to name just a few. Each customer 10 may communicate directly or indirectly with input subsystem 101 in order to initiate the process of audio or visual tailoring and the appropriate payment for the service. The payment authorization subsystem is not shown on this figure. It may be, for example, the American Express network, the Discover network, the Visa or Master Card networks or any other clearing house or clearing method for approval of transactions.

FIG. 1B illustrates an exemplary process for collecting input used to create personalized or tailored audio or visuals. During a typical transaction, a customer may access the service through input 101, which may include but are not limited to, an internet website, a call center, a cell phone communication Short Message Service (SMS) enabled site, to name just a few. The input subsystem, may transmit a request for payment authorization using a debit card or credit card network such as the American Express/Discover/Master Card/Visa interchange network or any other equivalent interchange network for processing purchase transactions. The input subsystem, may transmit at least one request for audio or visual personalization or tailoring to the Audio Visual Tailoring System, the Audio Visual Tailoring System may determine where the appropriate tailoring messages reside. Tailored Message Storage 50 may be accessed to meet the at least one request, the appropriate audio and/or video items may reside Audio/Video Storage 60 to meet the at least one request. Based on the at least one request from the input subsystem the Audio Visual Tailoring System may combine at least one message from the Tailored Message Storage 50 and at least one audio and/or video item from the Audio/Video Storage 60 and may create a personalized or tailored audio or visual composition. This composition may be created by adding the at least one message file and the at least one audio and/or video item file together. The composition may also be created by recording the at least one message and the at least one audio and/or video item together to form a new recorded audio and/or video file. One skilled in the art will understand that there are a number of commercially available software systems commonly available that allow multiple sound and or video files to be combined and/or recorded into a new compositions. Some of these audio mixing and mastering systems which may be used include, but are not limited to, Sonic Foundry's Sound Forge, Steinberg's Cubase and Cubasis, for digital sound recording and mixing from multiple sources. Some of these audio/video mixing and mastering systems which may be used, but are not limited to Adobe Premier, Final Cut Pro, Vegas Movie Studio, for digital video and sound recording and mixing from multiple sources.

This composition may be created in a plurality of forms. These forms may include digital image, digital sound, digital video, digital audio, analog sound analog audio and paper to name a few. The digital file formats may include any of a number of standard types of visual or audio formats, including but not limited to, *.tif, *.tga, *.ppt, *. prn, *.doc, *.pdf, *.cdw, *.eps, *.jpg, *.Jpeg, *.jpe, *.png, *.ps, *.rtf, *.txt, *.aif, *.wav, *.snd, *,au, *.aifc, *.aiff, *.wma, *.cda, *.asx, *,wax, *.m3u, *.wvx, *.wmx, *.mid, *.mpeg, *.mpg, *.m1v, *.mp2, *.avi, *.wmv, *.asf, *.wm, *.wma, *. Wmv to name just a few. The personalized or tailored audio or visual composition may then be stored in Tailored Audio/Video Storage 80 in any standard types of visual or audio formats. The Tailored Audio/ideo output 90 may then be distributed in standard types of visual or audio formats, and may be distributed through any of a number of mechanisms. For example these may include distribution by: email, the internet, satellite, broadcast, a cell phone, and through the national mail system. The tailored audiol video output 90 may also be fixed into a tangible medium which may include analog tape, digital tape, Compact disc, DVD, Laser Disc, floppy disk, RAM, ROM, Zip Disk, mini-disc, integrated circuit, flash memory, thumb drives and paper to name a few. One skilled in the art will realize that this list of tangible mediums is used for illustrative purposes and is not written to limit the invention and the method for distributing personalized or tailored audio or visuals.

FIG. 1C is a block diagram illustrating an exemplary audio visual tailoring system 106, consistent with the principles of the present invention. Audio visual tailoring system 106 may be any general-purpose computing system, such as a mainframe computer, a mini-computer, a single or multi-processor UNIX system, or a powerful PC server system. In any case, such a system may have at least one input device, such as an input device 102. Possible input devices include network interfaces, keyboards, mice, speech recognition devices, or document, video, or image input devices. Additionally, audio visual tailoring system 106 may have at least one output device 108, such as for example, display devices, network interfaces, printers, or sound or speech output devices.

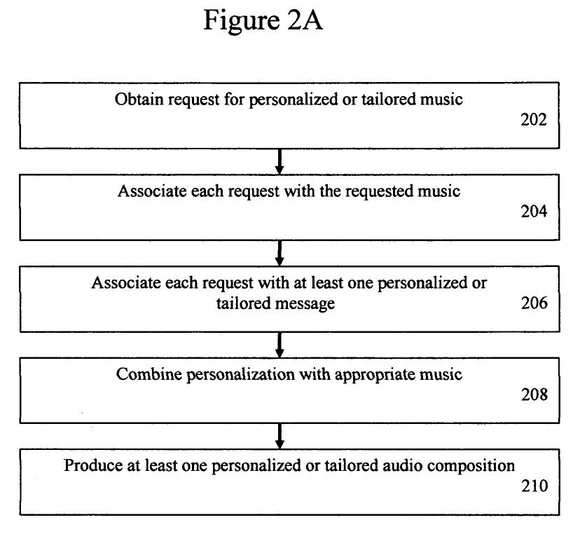

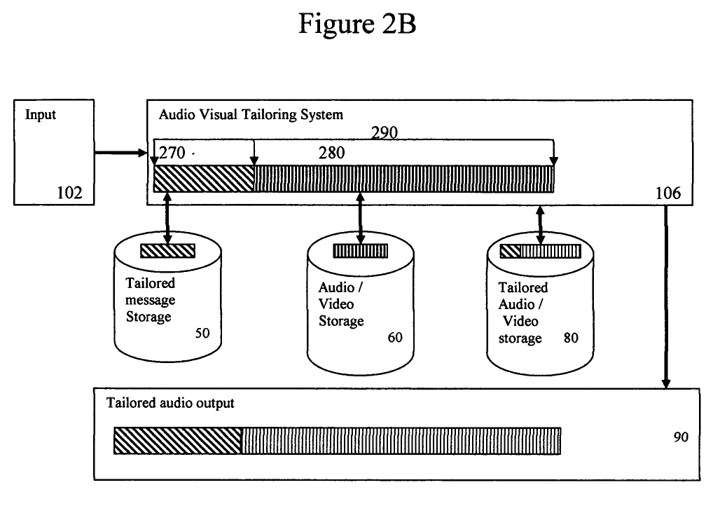

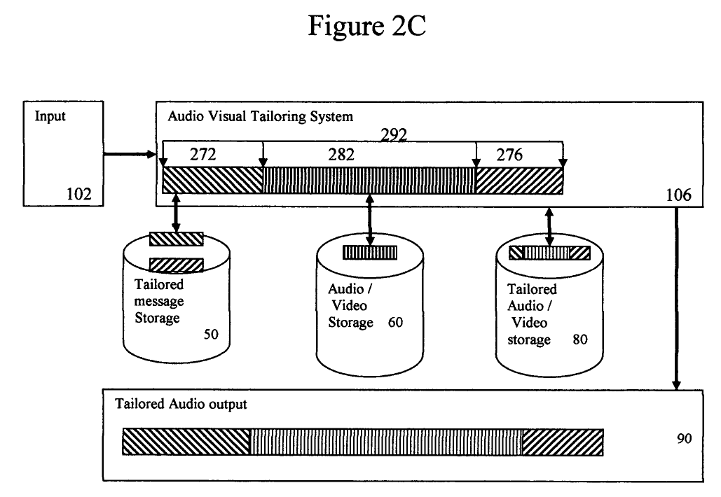

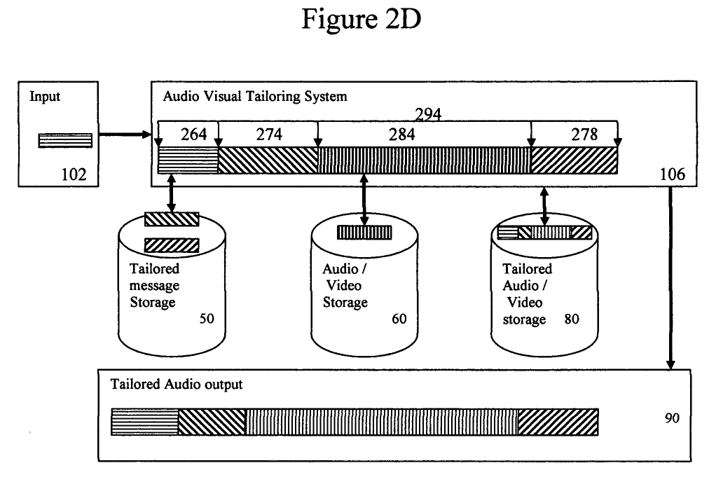

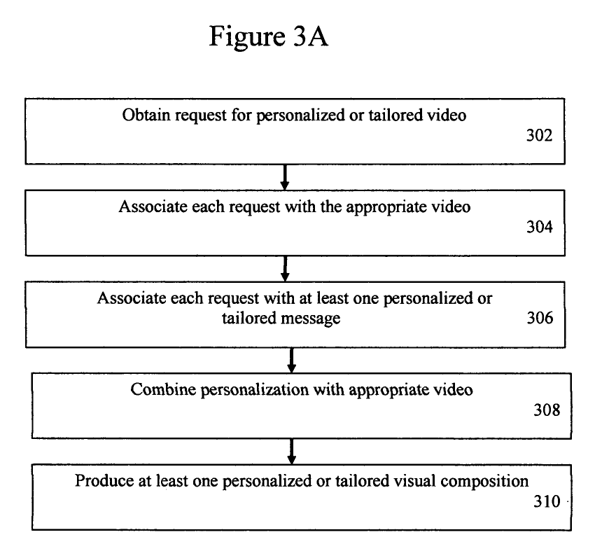

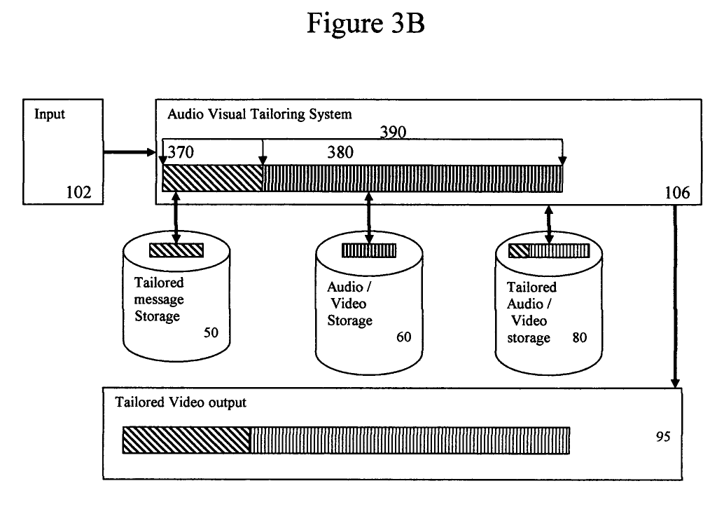

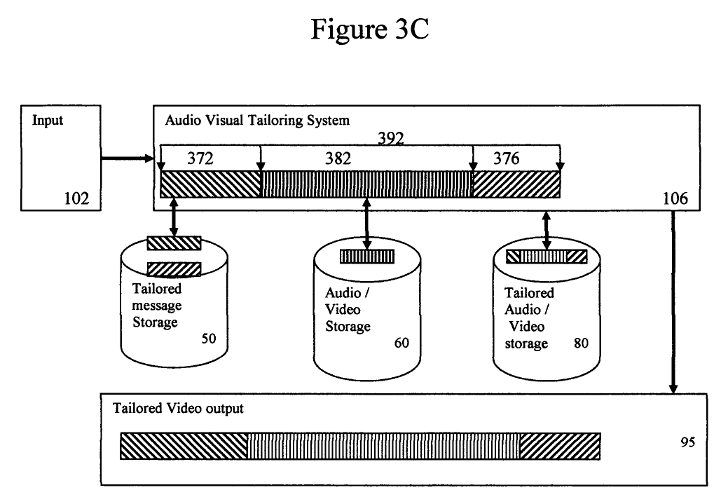

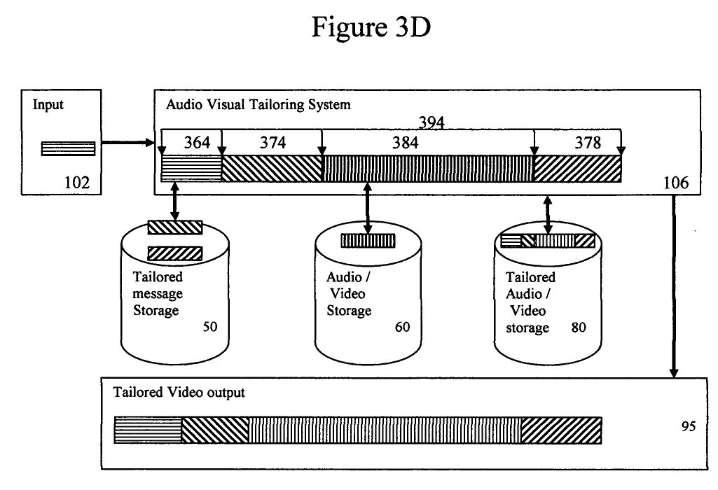

As illustrated in FIG. 1C, audio visual tailoring system 106 may also include at least one central processing unit (“CPU”) 104. CPU 104 may execute software programs for implementing the processes described below with respect to FIGS. 2A-3D. One skilled in the art will appreciate that although FIG. 1C shows one CPU, multiple CPUs may execute the aforementioned software programs. These software programs may reside in memory 110 of audio visual tailoring system 106. For instance, memory 110 may include database tables 140 comprising records, such as, tailored audio and/or video messages, account transaction records, which are discussed more with respect to FIGS. 2A-3D below, and software 150 for manipulating the records of database tables 140. Memory 110 may also access Recorded Audio/Video files 120, which may include audio images, visual images, musical phrases, songs, video clips, motion pictures, which may be used in the creation of personalized or tailored audio or visual compositions.

In one embodiment, software 150 may interact with various modules (described below) stored in memory 110 to process records stored in database tables 140. Thus, for example, software 150 may be relational database software which may interface with any software module or program that may query, sort, segment, or generate compositions or reports by processing records stored in database tables 130. One skilled in the art will appreciate that any object oriented techniques or other computational techniques may also be used consistent with the present invention to manipulate records stored in database tables 140. Indeed, based on object oriented techniques, records stored in database tables 140 may be represented as objects and may not be stored as part of any table. In other words, database tables 140 and software 150 are merely exemplary, and records, or equivalents thereof, may be processed using other known computing techniques and arrangements.

CPU 104 may use Tailoring modules 130 and Recorded Audio/Video files 120 when executing instructions in conjunction with the database software for creating the composition requested from input device 102.

One skilled in the art will appreciate that the data of database tables 140 and the processes implemented by software 150 and tailoring modules 130 may be combined or distributed in any manner consistent with the present invention. Indeed, database tables 140, database software 150, and tailoring modules 130 may be stored in any combination of memories, such as those located in a distributed computing network, and thus need not be located on the same computer system, or even in the same physical location.

Memory 110 may further include tailoring modules 130 and Recorded Audio/Video files 120. These modules when executed by CPU 104 for example, provide the functionality associated with the flow charts of FIGS. 2A and 3A, discussed below. For example, FIG. 1D illustrates exemplary sub-modules of tailoring modules (130 of FIG. 1C). Tailoring modules 130 may further include an Event Tailoring module 132, Name Tailoring module 134, Location Tailoring Module 136. Each of these modules may be implemented in software, firmware, hardware, or any combination thereof. Further, although FIG. 1D shows three different modules, they may be combined in any fashion and may be located on the same system or implemented across a distributed computing system.

FIG. 2A illustrates a flow chart of an exemplary method for creating personalized or tailored musical composition. As shown in FIG. 2A, a personalized or tailored audio system consistent with the present invention collects or obtains tailoring request data (step 202). The request data may come from at least one customer and will be for the tailoring of at least one audio or visual composition. In one embodiment, the request may be for the customers own personal benefit. In another embodiment the request may be for the benefit of a third party such as a spouse, friend or other individual.

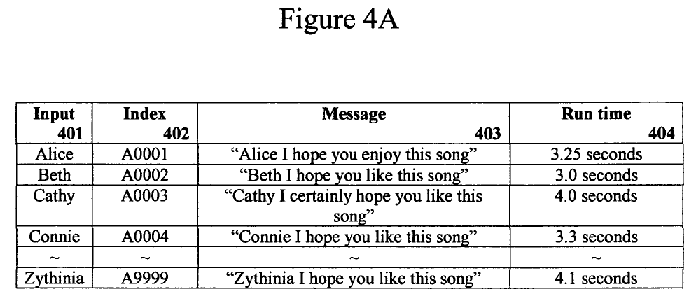

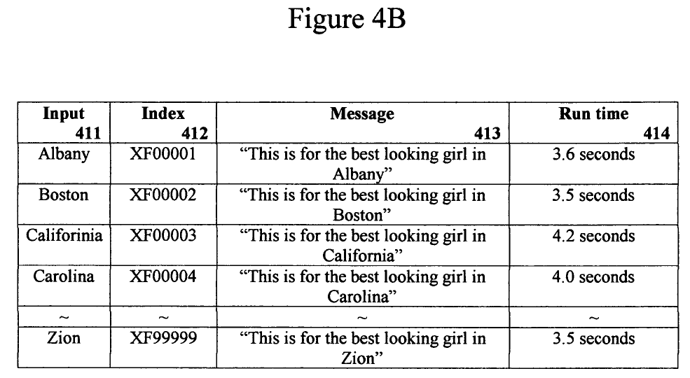

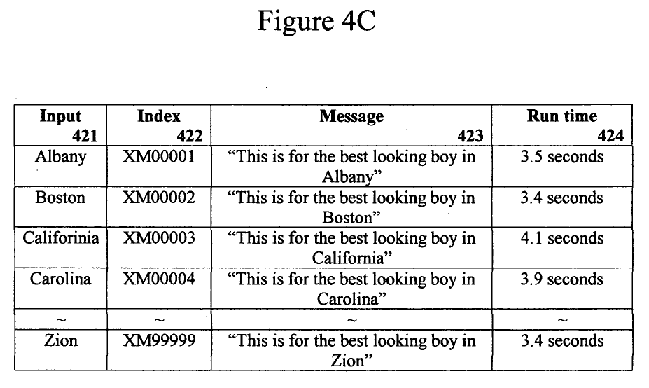

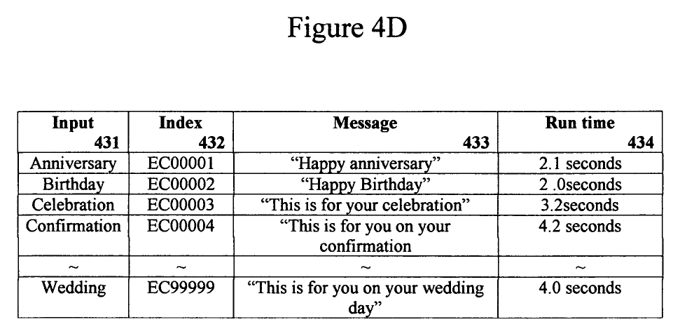

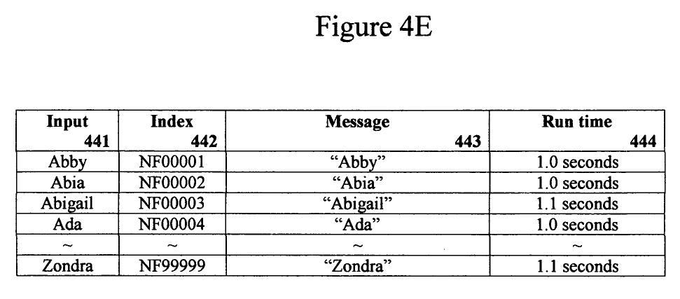

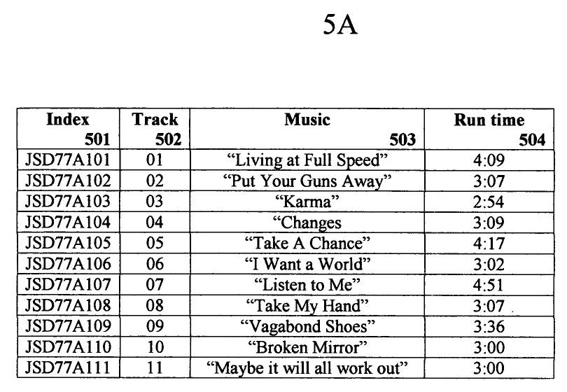

Tailoring modules 130 may then associate the request with the appropriate music (step 204). This may be done by using the data from the request (input 102) which may bring the music into systems memory 110. The identification of the appropriate music may be done by utilizing the indexes exemplary indexes found in FIGS. 4A-5.

The tailoring modules 130 then identifies at least one requested message (step 206), which may be brought into the systems memory 110. This may be done by using the data from the request (input 102) and utilizing the exemplary indexes found in FIGS. 4A-5.

The Audio Visual Tailoring system may then combine the requested music and the requested tailored message (Step 208), In one embodiment, module 132 may identify and obtain an event requested for the tailoring from Tailored Message storage 50—FIG. 1B (e.g., Index EC00001 “Happy Anniversary” FIG. 4D). This message may be combined with music from Audio Video Storage 60—FIG. 1B (e.g. JSD77A108 “Take My Hand” 5A)

The exemplary method may combine the two files into a new audio composition that may be output (Step 210) through Output Device 108 (FIG. 1C) The output may be stored in Tailored Audio/Video Storage 80 (FIG. 1B) The output may also be distributed through Tailored Audio/Video output 90 (FIG. 1B)

To more effectively describe a few of the embodiments of the Audio Visual tailoring system several examples have been created. (FIGS. 2B-2D).

In actual practice FIGS. 2B, 2C, and 2D and the embodiments that they exemplify would each occur separate and distinctly from one another. In other words, none of the FIGS. 2B, 2C, and 2d are dependent upon one another. Each figure and the embodiment it represents is independent. They are listed and discussed in sequence in the figures solely to aid in the understanding of the invention.

FIG. 2B shows an embodiment of the invention in which a request comes into the Audio Visual Tailoring System through Input (102). For illustrative purposes only, this request is for a single tailored message (270), which was requested to be placed before the audio (280). As was previously noted above the request can be for the benefit of the requestor (customer) or for the benefit of some other 3^{rd} party, (another fan of the music) for this embodiment we may assume that the tailoring request was for the Artist to say “Alice I hope you enjoy this song” (FIG. 4A—Index A0001). This message may be supplied from Tailored Message Storage 50 (FIG. 2B) In this example, the song selected is “Vagabond Shoes” (5A—Index JSD77A109). This message may be supplied from Audio/Video Storage 60 (FIG. 2B). Audio Visual Tailoring system 106 may combine the two audio files through merging into a single composition or by being rerecorded into a single compositions or any other manner, (FIG. 2B—270 plus 280 to create 290 ) and a new run time for the composition may be calculated. Message 270=3.25 seconds (FIG. 4A—Index A001). Song 280=3:36 (5A—Index JSD77A109) The total run time may now calculated to be approximately 3:40 (0:03.25+3:36=3:40), the output format (of 290) requested from input (102) may than be created by the audio visual tailoring system (106). The output (290) may be sent to Tailored Audio/Video storage (80) in at least one requested, or system specified, format. The output (290) may be sent to Tailored Audio Output (90) in at least one requested format.

FIG. 2C shows another embodiment of the invention, to help maintain consistency of the discussion the previous example regarding FIG. 2B will be built upon. (As mentioned above, FIGS. 2B, 2C and 2D are separate and distinct embodiments that do not require one another in actual practice. They are built upon here solely for the purpose of facilitating understanding) For FIG. 2C, a request comes into the Audio Visual Tailoring System through Input (102). For illustrative purposes only, this request is for two tailored messages (272 and 276), Message 272 was requested to be placed before the audio (282). Message 276 was requested to be placed after the audio (282) As was previously noted above the request can be for the benefit of the requestor (customer) or for the benefit of some other 3^{rd} party, (another fan of the music). For this embodiment, we may assume that the tailoring request (272) was for the Artist to say “Alice I hope you enjoy this song” (FIG. 4A—Index A001). We may also assume that the tailoring request (276) which is to come after the song was for the Artist to say “Happy Birthday” (FIG. 4D—Index EC00002). This message may be supplied from Tailored Message Storage 50 (FIG. 2B) In this example the song selected is “Vagabond Shoes” (5A—Index JSD77A109) This message may be supplied from Audio/Video Storage 60 (FIG. 2B). Audio Visual Tailoring system 106 may combine the three audio files with any commercially available acceptable tool, (FIG. 2C—272 plus 282 plus 276 to create 292 ) A new run time for the composition is calculated. Message 272=3.25 seconds (FIG. 4A—Index A0001). Song 282=3:36 (5A—Index JSD77A109) Message 276=2.0 seconds (FIG. 4D—Index EC0002) The total run time is now calculated to be approximately 3:42 (0:03.25+3:36+0:02=3:42). The output format (of 292) requested from input (102) may than be created by the audio visual tailoring system (106). The output (292) may be sent to Tailored Audio/Video storage (80) in at least one requested or system specified format. The output (292) may be sent to Tailored Audio Output (90) in at least one requested format.

FIG. 2D shows another embodiment of the invention, to help maintain consistency of the discussion the previous examples FIGS. 2B and 2C will be built upon to help explain FIG. 2D. (As mentioned above, FIGS. 2B, 2C and 2D are separate and distinct embodiments that do not require one another in actual practice.) For FIG. 2D , a request comes into the Audio Visual Tailoring System through Input (102). For illustrative purposes only, this request is for two tailored messages (274 and 278), and a spoken message from the requestor (264),

Message 274 was requested to be placed before the audio (284). Message 278 was requested to be placed after the audio (284) in addition a customer spoken message 264 “Alice I Love you.” was requested. This spoken message may be prerecorded and converted to a digital format at the customer's location (e.g. *.wav, *.snd, *.aif, *.aiff etc.). It may also be recorded in input subsystem 102 in any number of formats as previously noted above (e.g. *.wav, *.snd, *.aif, *.aiff etc.) The customer supplied message 264 may then be brought into the Audio Visual Tailoring system (106). As was previously noted above the request can be for the benefit of the requestor (customer) or for the benefit of some other 3^{rd} party, (another fan of the music) in this example and for this embodiment we may assume that customer supplied message 264 “Alice I Love you.” has been supplied in an standard audio format that has a run time of 4 seconds, the tailoring request (274) was for the Artist to say “Alice I hope you enjoy this song” (FIG. 4A-Index A0001). We may also assume that the tailoring request (278) which is to come after the song was for the Artist to say “Happy Birthday” (FIG. 4D—Index EC0002). This message may be supplied from Tailored Message Storage 50 (FIG. 2B) In this example the song selected is “Vagabond Shoes” (5A—Index JSD77A109) This message may be supplied from Audio/Video Storage 60 (FIG. 2B) Audio Visual Tailoring system 106 may combine the four audio files using any acceptable commercially available software, firmware or hardware, such as Steinberg Cubase program, (Customer supplied 264 “Alice I love you.” plus FIG. 2D—274 plus 284 plus 278 to create 294 ) A new run time for the composition is calculated. Customer supplied message 264=4 seconds Message 272=3.25 seconds (FIG. 4A—Index A0001) Song 282=3:36 (5A—Index JSD77A109) Message 276=2.0 seconds (FIG. 4D—Index EC0002) The total run time is now calculated to be approximately 3:46 (0:04+0:03.25+3:36+0:02=3:46), the output format (of 294) requested from input (102) may then be created by the audio visual tailoring system (106). The output (294) may be sent to Tailored Audio/Video storage (80) in at least one requested or system specified format. The output (294) may be sent to Tailored Audio Output (90) in at least one requested format.

FIG. 3A illustrates a flow chart of an exemplary method for creating personalized or tailored visual composition. As shown in FIG. 3A, a personalized or tailored video system consistent with the present invention collects or obtains tailoring request data (step 302). The request data may come from at least one customer and will be for the tailoring of at least one audio or visual composition. In one embodiment, the request may be for the customer's own personal benefit. In another embodiment, the request may be for the benefit of a third party such as a spouse, friend, or other individual.

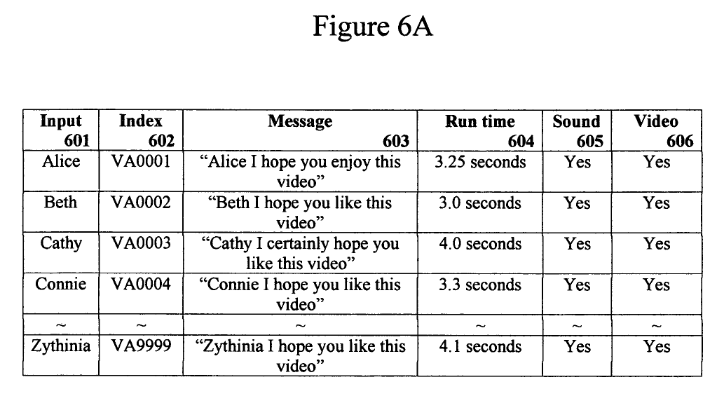

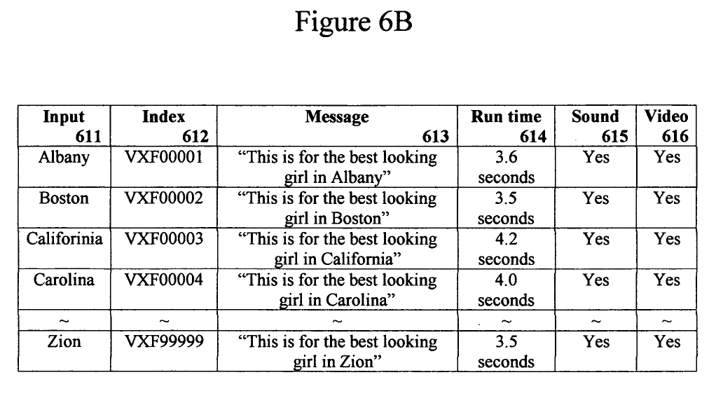

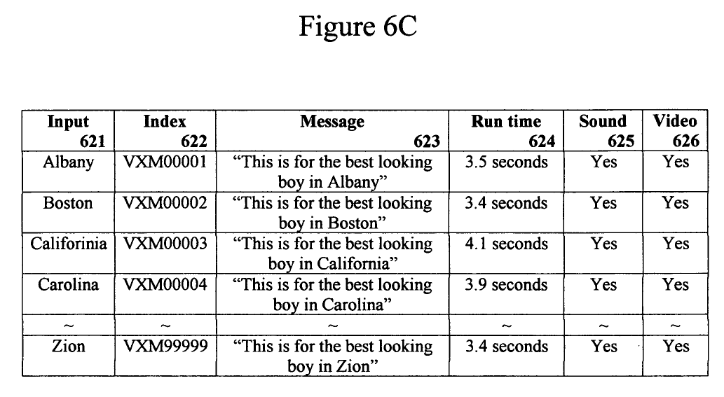

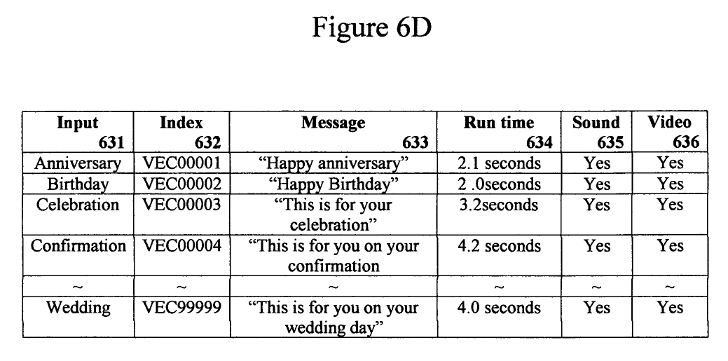

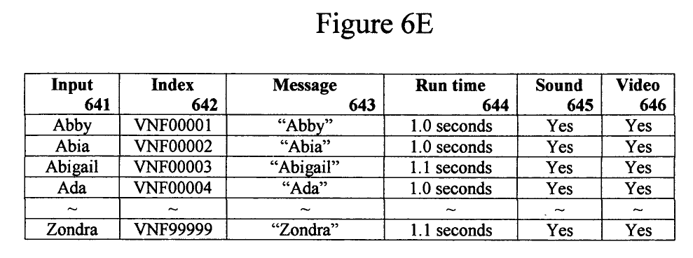

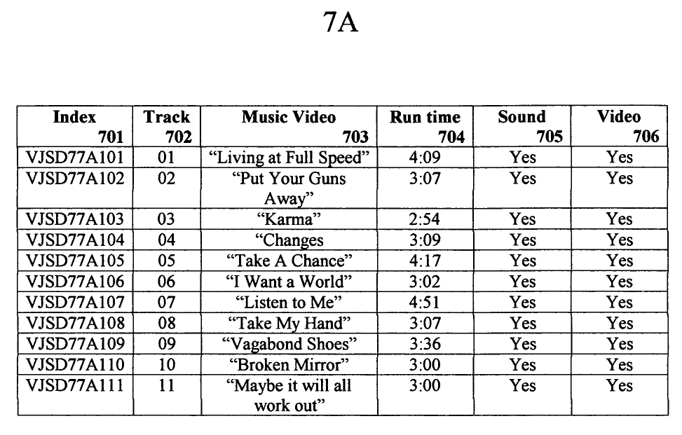

Tailoring modules 130 (FIG. 1C) may then associate the request with the appropriate video (step 304). This may be done by using the data from the request (input 102) which may bring the music into systems memory 110. The identification of the appropriate video may be done by utilizing the indexes exemplary indexes found in FIGS. 6A-7.

The tailoring modules 130 then identifies at least one requested message(step 306) which may bring the video into the system memory 110. Module 130 may bring audio into the system memory 110. Module 130 may bring both audio and video into the system memory 110. This may be done by using the data from the request (input 102) and utilizing the exemplary indexes found in FIGS. 6A-7.

The Audio Visual Tailoring system may then combine the requested visual, video clip, or motion picture and the requested tailored message (Step 308), In one embodiment, module 132 may identify and obtain an event requested for the tailoring from Tailored Message storage 50—FIG. 1B (e.g., Index VEC00001 “Happy Anniversary” FIG. 6D) this may be in the form of audio only, video only or audio and video together. This message may be combined with audio, video and/or music from Audio Video Storage 60—FIG. 1B (e.g.VJSD77A108 “Take My Hand” 7A)

The exemplary method may combine the two files into a new video composition that the may be output (Step 310) through Output Device 108 (FIG. 1C) The output may be stored in Tailored Audio/Video Storage 80 (FIG. 1B) The output may also be distributed through Tailored Audio/Video output 90 (FIG. 1B)

To more effectively describe a few of the embodiments of the Audio Visual tailoring system several examples have been created. (FIGS. 3B-3D).

In actual practice FIGS. 3B, 3C, and 3D and the embodiments that they exemplify would each occur separate and distinctly from one another. In other words, none of the FIGS. 3B, 3C, and 3D are dependent upon one another. Each figure and the embodiment it represents is independent. They are listed and discussed in sequence in the figures solely to aid in the understanding of the invention.

FIG. 3B shows an embodiment of the invention in which a request comes into the Audio Visual Tailoring System through Input (102). For illustrative purposes only, this request is for a single tailored message (370), which was requested to be placed before the video (380). As was previously noted above, the request can be for the benefit of the requestor (customer) or for the benefit of some other 3^{rd} party, (another fan of the video, motion picture, music etc.) for this embodiment we may assume that the tailoring request was for the Artist on video to say “Alice I hope you enjoy this video” (FIG. 6A—Index VA0001). This message may be supplied from Tailored Message Storage 50 (FIG. 3B) In this example the music video selected is “Vagabond Shoes” (7A—Index VJSD77A109) This message may be supplied from Audio/Video Storage 60 (FIG. 3B). Audio Visual Tailoring system 106 may combine the two video files using any of a number of commercially available audio/ video mixing and mastering system (such as Adobe's Premiere), (FIG. 3B—370 plus 380 to create 390) A new run time for the composition is calculated. Message 370=3.25 seconds (FIG. 6A—Index A0001). Video 380=3:36 (7A-Index VJSD77A109) The total run time is now calculated to be approximately 3:40 (0:03.25+3:36=3:40), the output format (of 390) requested from input (102) may than be created by the audio visual tailoring system (106). The output (390) may be sent to Tailored Audio/Video storage (80) in at least one requested or system specified format. The output (390) may be sent to Tailored Video Output (95) in at least one requested format.

FIG. 3C shows another embodiment of the invention, to help maintain consistency of the discussion the previous example regarding FIG. 3B will be built upon. (As mentioned above, FIGS. 3B, 3C and 3D are separate and distinct embodiments that do not require one another in actual practice.) For FIG. 3C , a request comes into the Audio Visual Tailoring System through Input (102). For illustrative purposes only, this request is for two tailored messages (372 and 376), Message 372 was requested to be placed before the video (282). Message 376 was requested to be placed after the video (382) As was previously noted above, the request may be for the benefit of the requester (customer) or may be for the benefit of some other 3^{rd} party, (another fan of the music) for this embodiment we may assume that the tailoring request (372) was for the Artist to say on video “Alice I hope you enjoy this song” (FIG. 6A—Index VA0001). We may also assume that the tailoring request (376) which is to come after the song was for the Artist to say on video “Happy Birthday” (FIG. 6D—Index VEC0002). This message may be supplied from Tailored Message Storage 50 (FIG. 3B) In this example, the music video selected is “Vagabond Shoes” (7A—Index VJSD77A109) This message may be supplied from Audio/Video Storage 60 (FIG. 3B). Audio Visual Tailoring system 106 may combine the three video files, (FIG. 3C—372 plus 382 plus 376 to create 392 ) an a new run time for the composition is calculated. Message 372=3.25 seconds (FIG. 6A—Index VA0001). Music Video 382=3:36 (7A—Index VJSD77A109) Message 376=2.0 seconds (FIG. 6D—Index VEC00002) The total run time is now calculated to be approximately 3:42 (0:03.25+3:36+0:02=3:42), the output format (of 392) requested from input (102) may than be created by the audio visual tailoring system (106). The output (392) may be sent to Tailored Audio/Video storage (80) in at least one requested or system specified format. The output (392) may be sent to Tailored Video Output (95) in at least one requested format.

FIG. 3D shows another embodiment of the invention. To help maintain consistency of the discussion the previous examples, and for illustrative purposes only FIGS. 3B and 3C will be built upon to help explain FIG. 3D. (As mentioned above, FIGS. 3B, 3C and 3D are separate and distinct embodiments that do not require one another in actual practice.) For FIG. 3D, a request comes into the Audio Visual Tailoring System through Input (102). For illustrative purposes only, this request is for two tailored messages (374 and 378), and a video message from the requester (364),

Message 374 was requested to be placed before the video (384). Message 378 was requested to be placed after the video (384) in addition a customer video message 364 “Alice I Love you.” was requested. This video message may be prerecorded and converted to a digital format at the customer's location (e.g. *.mpeg, *.mpg, *.m1v, *.mp2, *.avi, *.wmv, *.asf etc.). It may also be recorded in input subsystem 102 and may utilize a camera at the customer's location which may be remotely controlled by input subsystem 102 in any number of formats as previously noted above (e.g. *.mpeg, *.mpg, *.m1v, *.mp2, *.avi, *.wmv, *.asf etc.) The customer supplied message 364 may then be brought into the Audio Visual Tailoring system (106). As was previously noted above, the request can be for the benefit of the requestor (customer) or for the benefit of some other 3^{rd} party, (another fan of the video, motion picture or music) in this example, and for this embodiment, we may assume that customer supplied message 364 “Alice I Love you.” has been supplied in an standard video format that has a run time of 4 seconds, the tailoring request (374) was for the Artist to say “Alice I hope you enjoy this song” (FIG. 6A—Index VA0001). We may also assume that the tailoring request (378) which is to come after the song was for the Artist to say “Happy Birthday” (FIG. 6D—Index VEC00002). This message may be supplied from Tailored Message Storage 50 (FIG. 3B) In this example the music video selected is “Vagabond Shoes” (7A—Index VJSD77A109) This message may be supplied from Audio/Video Storage 60 (FIG. 3B). Audio Visual Tailoring system 106 may combine the four video files, (Customer supplied 364 “Alice I love you.” plus FIG. 3D—374 plus 384 plus 378 to create 394 ) an a new run time for the composition is calculated. Customer supplied message 364=4 seconds Message 372=3.25 seconds (FIG. 6A—Index VA0001) Song 382=3:36 (7A—Index VJSD77A109) Message 376=2.0 seconds (FIG. 4D—Index VEC00002) The total run time is now calculated to be approximately 3:46 (0:04+0:03.25+3:36+0:02=3:46), the output format (of 394) requested from input (102) may then be created by the audio visual tailoring system (106). The output (394) may be sent to Tailored Audio/Video storage (80) in at least one requested or system specified format. The output (394) may be sent to Tailored Video Output (95) in at least one requested format.

FIG. 4A illustrates an exemplary tailored message table which may be part of an exemplary method for creating personalized or tailored musical composition. The columns and rows are for illustrative purposes only and may include more, or fewer columns and rows in the invention. For illustrative purposes only, FIG. 4A, may contain, an Input column 401 which may consist of a plurality of rows, an Index column with a message column which may consist of a plurality of rows and a run time column which may consist of a plurality of rows. In exemplary FIG. 4A, the Input column 401 contains the name of the individual for which the final message may be tailored.; the Index column 402 contains a unique identifier for each row, the Index column in 402 shows a five position alpha-numeric index code, one skilled in the art will understand that this five position code may contain more positions or fewer positions, Message column 403 contains the recorded message that is tailored to the individual, this message may be created by the artist, the message may be created by someone other than the artist who is valued by the customer or the final beneficiary of the tailoring. The Run Time column 404 may contain the elapsed time from the start of the message until the end of the message. The data in this column may be useful in determining the run time of complete tailored message. The data from this table may be stored in the Tailored message storage 50 (FIG. 1B) personalized or tailored video system consistent with the present invention collects or obtains tailoring request data.

FIG. 4B illustrates an exemplary tailored message table which may be part of an exemplary method for creating personalized or tailored musical composition. The columns and rows are for illustrative purposes only and may include more, or fewer columns and rows in the invention. For illustrative purposes only, FIG. 4B, may contain, an Input column 411 which may consist of a plurality of rows, an Index column which a message column which may consist of a plurality of rows and a run time column which may consist of a plurality of rows. In exemplary FIG. 4B, the Input column 411 contains the name of the location for which the final message may be tailored.; the Index column 412 contains a unique identifier for each row, the Index column in 412 shows a seven position alpha-numeric index code, one skilled in the art will understand that this seven position code may contain more positions or fewer positions, Message column 413 contains the recorded message that is tailored to the location. This message may be created by the artist, the message may be created by someone other than the artist who is valued by the customer or the final beneficiary of the tailoring. The Run Time column 414 may contain the elapsed time from the start of the message until the end of the message. The data in this column may be useful in determining the run time of complete tailored message. The data from this table may be stored in the Tailored message storage 50 (FIG. 1B)

FIG. 4C illustrates an exemplary tailored message table which may be part of an exemplary method for creating personalized or tailored musical composition. The columns and rows are for illustrative purposes only and may include more, or fewer columns and rows in the invention. For illustrative purposes only, FIG. 4C, may contain, an Input column 421 which may consist of a plurality of rows, an Index column with a message column which may consist of a plurality of rows and a run time column which may consist of a plurality of rows. In exemplary FIG. 4C, the Input column 421 contains the name of the location for which the final message may be tailored.; the Index column 422 contains a unique identifier for each row, the Index column in 422 shows a seven position alpha-numeric index code, one skilled in the art will understand that this seven position code may contain more positions or fewer positions, Message column 423 contains the recorded message that is tailored to the location. This message may be created by the artist, the message may be created by someone other than the artist who is valued by the customer or the final beneficiary of the tailoring. The Run Time column 424 may contain the elapsed time from the start of the message until the end of the message. The data in this column may be useful in determining the run time of a complete tailored message. The data from this table may be stored in the Tailored message storage 50 (FIG. 1B)

FIG. 4D illustrates an exemplary tailored message table which may be part of an exemplary method for creating personalized or tailored musical composition. The columns and rows are for illustrative purposes only and may include more, or fewer columns and rows in the invention. For illustrative purposes only, FIG. 4D, may contain, an Input column 431 which may consist of a plurality of rows, an Index column with a message column which may consist of a plurality of rows and a run time column which may consist of a plurality of rows. In exemplary FIG. 4D, the Input column 431 contains the name of the event for which the final message may be tailored.; the Index column 432 contains a unique identifier for each row, the Index column in 432 shows a seven position alpha-numeric index code, one skilled in the art will understand that this seven position code may contain more positions or fewer positions, Message column 433 contains the recorded message that is tailored to the event, this message may be created by the artist, the message may be created by someone other than the artist who is valued by the customer or the final beneficiary of the tailoring. The Run Time column 434 may contain the elapsed time from the start of the message until the end of the message. The data in this column may be useful in determining the run time of complete tailored message. The data from this table may be stored in the Tailored message storage 50 (FIG. 1B)

FIG. 4E illustrates an exemplary tailored message table which may be part of an exemplary method for creating personalized or tailored musical composition. The columns and rows are for illustrative purposes only and may include more, or fewer columns and rows in the invention. For illustrative purposes only, FIG. 4E, may contain, an Input column 441 which may consist of a plurality of rows, an Index column with a message column which may consist of a plurality of rows and a run time column which may consist of a plurality of rows. In exemplary FIG. 4E, the Input column 441 contains the name of the individual for which the final message may be tailored.; the Index column 442 contains a unique identifier for each row, the Index column in 442 shows a seven position alpha-numeric index code, one skilled in the art will understand that this seven position code may contain more positions or fewer positions, Message column 443 contains the recorded message that is tailored to the individual, this message may be created by the artist, the Message may be created by someone other than the artist who is valued by the customer or the final beneficiary of the tailoring. The Run Time column 444 may contain the elapsed time from the start of the message until the end of the message. The data in this column may be useful in determining the run time of the complete tailored message. The data from this table may be stored in the Tailored message storage 50 (FIG. 1B). One skilled in the art will recognize from the exemplary descriptions provided of exemplary tables 4D and 4E that these two tables may be combined with message output placed together either before or after one another to create an extremely extensive number of potentially tailored messages.

5A shows an exemplary table consistent with the present invention. The table in 5A may contain fewer or more columns than are used in this example. For illustrative purposes only, we have included an exemplary table which is comprised of the complete contents of a popular music album. The album is split into tracks. Each track is comprised of a complete musical phrase, the complete phrase in this illustration also happens to be a complete song. This may or may not be the case with the invention, consistent with the invention a musical phrase does not have to be a complete song and may be at least one sound. Index column 501 is a unique identifier for the track. It may be any number of alpha-numeric characters. In our illustration, Track column 502 is an identifier that may be linked back to the original item. In the illustration it may be noted that the track number found in column 502 is identical to the last two characters in the Index 501 column, this is coincidental, and may or may not be the case in the invention. Music Column 503 contains the name by which the audio may be identified. In our example it is the artist's title for the audio, this may or may not be the case in the invention. Run Time Column 504 may be the elapsed time from the beginning of the audio until the completion of the audio. The run time 504 entry may be useful in calculating the total run time of the personalized or tailored audio composition

FIG. 6A illustrates an exemplary tailored message table which may be part of an exemplary method for creating personalized or tailored musical composition. The columns and rows are for illustrative purposes only and may include more, or fewer columns and rows in the invention. For illustrative purposes only, FIG. 6A, may contain, an Input column 601 which may consist of a plurality of rows, an Index column, a message column which may consist of a plurality of rows and a run time column which may consist of a plurality of rows. In exemplary FIG. 6A, the Input column 601 contains the name of the individual for which the final message may be tailored.; the Index column 602 contains a unique identifier for each row, the Index column in 602 shows a six position alpha-numeric index code, one skilled in the art will understand that this six position code may contain more positions or fewer positions, Message column 603 contains the recorded message that is tailored to the individual, this message may be created by the artist, the message may be created by someone other than the artist who is valued by the customer or the final beneficiary of the tailoring. The Run Time column 604 may contain the elapsed time from the start of the message until the end of the message. The data in this column may be useful in determining the run time of the complete tailored message. Sound Column 605 may contain a simple yes/no indicator which would indicate whether or not the message contains sound. Video column 606 may contain a simple yes/no indicator which would indicate whether the message contains video. If the indicator of video 606 was no, this may enable the audio visual tailoring system to run the message over a freeze frame of the last picture in the video. One skilled in the art will know that the system could also run the message over Black instead of a last freeze frame. This may be referred to as voice over video. Other methods to tailor sound and video independent of one another may be considered here and are consistent with the present invention. The data from this table may be stored in the Tailored message storage 50 (FIG. 1B) personalized or tailored video system consistent with the present invention collects or obtains tailoring request data.

FIG. 6B illustrates an exemplary tailored message table which may be part of an exemplary method for creating personalized or tailored musical composition. The columns and rows are for illustrative purposes only and may include more, or fewer columns and rows in the invention. For illustrative purposes only, FIG. 6B, may contain, an Input column 611 which may consist of a plurality of rows, an Index column, a message column which may consist of a plurality of rows and a run time column which may consist of a plurality of rows. In exemplary FIG. 6B, the Input column 611 contains the name of the location for which the final message may be tailored.; the Index column 612 contains a unique identifier for each row, the Index column in 612 shows a eight position alpha-numeric index code. One skilled in the art will understand that this eight position code may contain more positions or fewer positions, Message column 613 contains the recorded message that is tailored to the individual, this message may be created by the artist, the message may be created by someone other than the artist who is valued by the customer or the final beneficiary of the tailoring. The Run Time column 614 may contain the elapsed time from the start of the message until the end of the message. The data in this column may be useful in determining the run time of complete tailored message. Sound Column 615 may contain a simple yes/no indicator which would indicate whether or not the message contains sound. Video column 606 may contain a simple yes/no indicator which would indicate whether the message contains video. If the indicator of video 616 was no, this may enable the audio visual tailoring system to run the message over a freeze frame of the last picture in the video. One skilled in the art will know that the system could also run the message over Black instead of a last freeze frame. This may be referred to as voice over video. Other methods to tailor sound and video independent of one another may be considered here and are consistent with the present invention. The data from this table may be stored in the Tailored message storage 50 (FIG. 1B).

FIG. 6C illustrates an exemplary tailored message table which may be part of an exemplary method for creating personalized or tailored musical composition. The columns and rows are for illustrative purposes only and may include more, or fewer columns and rows in the invention. For illustrative purposes only, FIG. 6C, may contain; an Input column 621 which may consist of a plurality of rows, an Index column, a message column which may consist of a plurality of rows and a run time column which may consist of a plurality of rows. In exemplary FIG. 6C, the Input column 621 contains the name of the location for which the final message may be tailored.; the Index column 622 contains a unique identifier for each row, the Index column in 622 shows an eight position alpha-numeric index code, one skilled in the art will understand that this eight position code may contain more positions or fewer positions, Message column 623 contains the recorded message that is tailored to the individual, this message may be created by the artist, the message may be created by someone other than the artist who is valued by the customer or the final beneficiary of the tailoring. The Run Time column 624 may contain the elapsed time from the start of the message until the end of the message. The data in this column may be useful in determining the run time of complete tailored message. Sound Column 625 may contain a simple yes/no indicator which would indicate whether or not the message contains sound. Video column 606 may contain a simple yes/no indicator which would indicate whether the message contains video. If the indicator of video 626 was no, this may enable the audio visual tailoring system to run the message over a freeze frame of the last picture in the video. One skilled in the art will know that the system could also run the message over Black instead of a last freeze frame. This may be referred to as voice over video. Other methods to tailor sound and video independent of one another may be considered here and are consistent with the present invention. The data from this table may be stored in the Tailored message storage 50 (FIG. 1B).

FIG. 6D illustrates an exemplary tailored message table which may be part of an exemplary method for creating personalized or tailored musical composition. The columns and rows are for illustrative purposes only and may include more, or fewer columns and rows in the invention. For illustrative purposes only, FIG. 6D, may contain; an Input column 631 which may consist of a plurality of rows, an Index column, a message column which may consist of a plurality of rows and a run time column which may consist of a plurality of rows. In exemplary FIG. 6D, the Input column 631 contains the name of the event for which the final message may be tailored.; the Index column 632 contains a unique identifier for each row, the Index column in 632 shows an eight position alpha-numeric index code. One skilled in the art will understand that this eight position code may contain more positions or fewer positions, Message column 633 contains the recorded message that is tailored to the individual, this message may be created by the artist, the Message may be created by someone other than the artist who is valued by the customer or the final beneficiary of the tailoring. The Run Time column 634 may contain the elapsed time from the start of the message until the end of the message. The data in this column may be useful in determining the run time of the complete tailored message. Sound Column 635 may contain a simple yes/no indicator which would indicate whether or not the message contains sound. Video column 636 may contain a simple yes/no indicator which would indicate whether the message contains video. If the indicator of video 636 was no, this may enable the audio visual tailoring system to run the message over a freeze frame of the last picture in the video. One skilled in the art will know that the system could also run the message over Black instead of a last freeze frame. This may be referred to as voice over video. Other methods to tailor sound and video independent of one another may be considered here and are consistent with the present invention. The data from this table may be stored in the Tailored message storage 50 (FIG. 1B).

FIG. 6E illustrates an exemplary tailored message table which may be part of an exemplary method for creating personalized or tailored musical composition. The columns and rows are for illustrative purposes only and may include more, or fewer columns and rows in the invention. For illustrative purposes only, FIG. 6E, may contain; an Input column 641 which may consist of a plurality of rows, an Index column, a message column which may consist of a plurality of rows and a run time column which may consist of a plurality of rows. In exemplary FIG. 6E, the Input column 641 contains the name of the individual for which the final message may be tailored; the Index column 642 contains a unique identifier for each row, the Index column in 642 shows an eight position alpha-numeric index code, one skilled in the art will understand that this eight position code may contain more positions or fewer positions. Message column 643 contains the recorded message that is tailored to the individual, this message may be created by the artist, the message may be created by someone other than the artist who is valued by the customer or the final beneficiary of the tailoring. The Run Time column 644 may contain the elapsed time from the start of the message until the end of the message. The data in this column may be useful in determining the run time of the complete tailored message. Sound Column 645 may contain a simple yes/no indicator which would indicate whether or not the message contains sound. Video column 646 may contain a simple yes/no indicator which would indicate whether the message contains video. If the indicator of video 646 was no, this may enable the audio visual tailoring system to run the message over a freeze frame of the last picture in the video. One skilled in the art will know that the system could also run the message over Black instead of a last freeze frame. This may be referred to as voice over video. Other methods to tailor sound and video independent of one another may be considered here and are consistent with the present invention. The data from this table may be stored in the Tailored message storage 50 (FIG. 1B). One skilled in the art will recognize from the exemplary descriptions provided of exemplary tables 6D and 6E that these two tables may be combined with message output placed together either before or after one another to create an extremely extensive number of potentially tailored messages.

7 shows an exemplary table consistent with the present invention. Consistent with the invention are various types of visual images, which include but are not limited to: Motion pictures, Television shows, music video, video clips, single video images, a plurality of video images a single visual image and a plurality of visual images. The table in 7A may contain fewer or more columns than are used in this example. For illustrative purposes only, we have included an exemplary table which is comprised of the complete contents of a popular music video album. The music video album is split into tracks. Each track is comprised of a complete video clip, the complete video clip in this illustration also happens to be a complete music video song. This may or may not be the case with the invention, consistent with the invention a video clip does not have to be a complete video and may be at least one image. Index column 701 is a unique identifier for the track. It may be any number of alpha-numeric characters. In our illustration, Track column 702 is an identifier that may be linked back to the original item. In the illustration it may be noted that the track number found in column 702 is identical to the last two characters in the Index 701 column, this is coincidental, and may or may not be the case in the invention. Music Video Column 703 contains the name by which the audio may be identified. In our example, it is the artist's title for the music video, this may or may not be the case in the invention. Run Time column 704 may be the elapsed time from the beginning of the audio until the completion of the audio. The run time 704 entry may be useful in calculating the total run time of the personalized or tailored audio composition. Sound Column 705 may contain a simple yes/no indicator which would indicate whether or not the message contains sound. Video column 706 may contain a simple yes/no indicator which would indicate whether the message contains video. If the indicator of video 706 was no, this may enable the audio visual tailoring system to run the message over a freeze frame of the last picture in the video. One skilled in the art will know that the system could also run the message over Black instead of a last freeze frame. This may be referred to as voice over video. Other methods to tailor sound and video independent of one another may be considered here and are consistent with the present invention.

What is claimed:

1. A method for creating at least one personalized or tailored composition, the method comprising:
collecting information from an individual or plurality of individuals;
associating the information collected with at least one creative composition;
associating the information collected with at least one personalized or tailored message;
combining the at least one creative composition with the at least one personalized or tailored message; and
creating at least one personalized or tailored composition.

2. The method of claim 1, wherein the at least one personalized or tailored composition is in digital form.

3. The method of claim 1, wherein the at least one personalized or tailored composition is in analog form.

4. The method of claim 1, wherein the at least one personalized or tailored composition is created for the benefit of the initiating individual or plurality of individuals.

5. The method of claim 1, wherein the at least one personalized or tailored composition is created for the benefit of at least one person other than the initiating individual or plurality of individuals.

6. The method of claim 1, wherein the at least one personalized or tailored composition is stored.

7. The method of claim 1, wherein the at least one personalized or tailored composition is distributed to an individual or a plurality of individuals.

8. The method of claim 1, wherein at least one metric regarding the transaction is stored in a database.

9. A method of claim 8, wherein metrics gathered are used to pay the appropriate artist and publisher for the duplication of the work.

10. The method of claim 1, wherein at least one metric regarding the personalized or tailored composition is stored.

11. A method of claim 1, wherein the information collected contains a customer supplied audio and/or video image.

12. A system for creating personalized or tailored compositions, the system comprising:
means for collecting information from an individual or plurality of individuals;
means for associating the information collected with at least one creative composition;
means for associating the information collected with at least one personalized or tailored message;
means for combining the at least one creative composition with the at least one personalized or tailored message; and
means for creating at least one personalized or tailored composition.

13. The system of claim 12, wherein the at least one personalized or tailored composition is in digital form.

14. The system of claim 12, wherein the at least one personalized or tailored composition is in analog form.

15. The system of claim 12, wherein the at least one personalized or tailored composition is created for the benefit of the initiating individual or plurality of individuals.

16. The system of claim 12, wherein the at least one personalized or tailored composition is created for the benefit of at least one person other than the initiating individual or plurality of individuals.

17. The system of claim 12, wherein the at least one personalized or tailored composition is stored in a database.

18. The system of claim 12, wherein the at least one personalized or tailored composition is distributed to an individual or a plurality of individuals.

19. The system of claim 12, wherein at least one metric regarding the transaction is stored in a database.

20. The system of claim 12, wherein at least one metric regarding the personalized or tailored composition is stored in a database.

21. A system of claim 20, wherein metrics gathered are used to pay the appropriate artist and publisher for the duplication of the work.

22. A system of claim 12, wherein the information collected contains a customer supplied audio and/or video image.
